(19) United States
(12) Patent Application Publication
(10) Pub. No.: US 2004/0024802 A1
(43) Pub. Date: Feb. 5, 2004

(54) High-performance programmable processing element for GF (2N)

(76) Inventor: Raheel Ahmed Khan, Tustin, CA (US)

Correspondence Address: RAHEEL KHAN, 4590 MACARTHUR BLVD # 500, NEWPORT BEACH, CA, 92660, US

(21) Appl. No.: 10/211,876

(22) Filed: Aug. 5, 2002

(51) Int. Cl. G06F 15/00

(52) U.S. Cl. 708/492

(57) ABSTRACT

Many functions in communication require Galois Field (GF). With the given processing elements, any kind of Transfer Function can be realized. This therefore provides a very scaleable and flexible computational and processing architecture.

### CROSS REFERENCE TO RELATED APPLICATION

I claim the benefit of the filing date of PPA 60/308,399 on Jul. 30, 2001.

### FEDERALLY SPONSORED RESEARCH

Not Applicable

### SEQUENCE LISTING OR PROGRAM

Not Applicable

### BACKGROUND

1. Field of the Invention

This invention relates to a scaleable and flexible Processing Element (PE) for GF (2ⁿ) computations.

2. Description of the Prior Art

High performance processing engines used in networking and communications applications are typically hard-wired. Software techniques are typically used when programmability/flexibility is required. Software approaches are inherently low performance whereas hardware approaches are inherently inflexible.

Instead of designing hard-wired circuits, this invention can be used to implement Encoding/Decoding, Forward Error Correction (FEC), Encrypt/Decrypt, Cyclic Redundancy Check (CRC), Scrambling and other types of GF (2ⁿ) functions. The same PE can be time-shared to implement multiple functions. For example, the PE can be used to compute the header CRC for a packet header and, later, it can be configured to compute CRC for the packet payload.

### SUMMARY OF INVENTION

This invention describes a single structure that can implement a variety of functions: CRC, scrambling, FEC, etc. It has programmable operations and can generate polynomials.

### DRAWINGS

### DRAWING FIGURES

The construction designed to carry out the invention will hereinafter be described, together with other features thereof.

The invention will be more readily understood from a reading of the following specification and by reference to the accompanying drawings forming a part thereof, wherein an example of the invention is shown, and wherein:

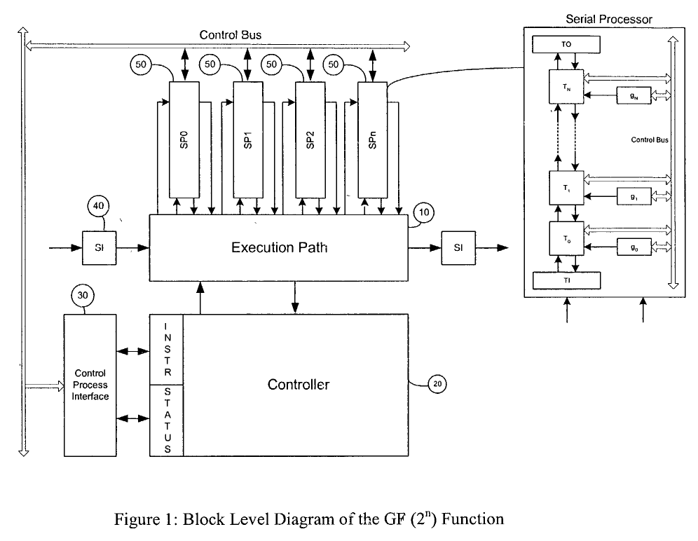

FIG. 1 is a diagram of the GF (2ⁿ) Functional Block

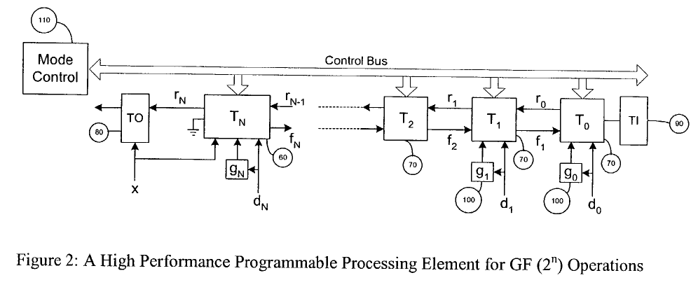

FIG. 2 is a diagram of A High Performance Programmable Processing Element for GF (2ⁿ) Operations

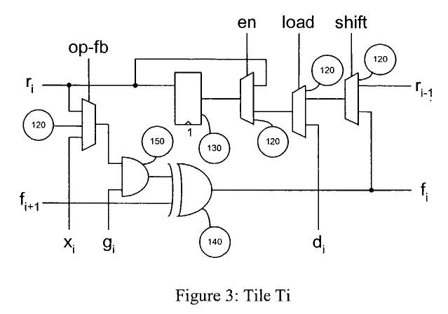

FIG. 3 is a diagram of Tile Tᵢ

### REFERENCE NUMERALS IN DRAWINGS

```
  10 Execution Path
  20 Controller
  30 Control Process Interface
  40 Serial Input
  50 Serial Processors
  60 Tile T_{N}
  70 Tile T
  80 Terminal Out
  90 Terminal In
100 Generator Polynomial
110 Mode Control
120 Multiplexer
130 Shift Register
140 Exclusive OR Gate
150 AND Gate
```

### DETAILED DESCRIPTION

Many Galois Field (GF) operations can be written in the form of matrix operations in GF (2ⁿ). CRC, Block Codes, Scrambling, Random Number Generation are some of the examples of operations that may be represented in this manner. A programmable processing element for these operations can be designed in this manner. This leads to a potentially very expensive implementation.

Alternatively, it is possible to view these operations as bit serial operations based on shift registers. This leads to a simple implementation.

From the description above, a number of advantages of this invention become evident:

(a) Highly cost effective design.

(b) Much simpler to implement.

We claim:

1. Programmable elements which can program a family of galois field functions.

2. A method of cascading programmable elements to realize complex transfer functions.

3. A programmable architecture which provides performance of hard wired approach.
